(19) United States
(12) Patent Application Publication
(10) Pub. No.: US 2025/0291639 A1
(43) Pub. Date: Sep. 18, 2025

(54) Scalable Offloading of Computer Vision Processing Tasks

(71) Applicants: Northeastern University, Boston, MA (US); Politecnico di Torino, Torino (IT)

(72) Inventors: Carla Fabiana Chiasserini, Torino (IT); Francesco Restuccia, Boston, MA (US); Tanzil Bin Hassan, Somerville, MA (US); Corrado Puligheddu, Cagliari (IT); Nancy Varshney, Torino (IT)

(21) Appl. No.: 19/073,801

(22) Filed: Mar. 7, 2025

Related U.S. Application Data
(60) Provisional application No. 63/564,937, filed on Mar. 13, 2024.

(51) Int. Cl. G06F 9/50

(52) U.S. Cl. CPC G06F 9/505; G06F 2209/5011; G06F 2209/509

(57) ABSTRACT

Tasks are distributed among a computing resource pool for operating a deep neural network (DNN) repository comprising a plurality of DNN models. A DNN configuration to process the task is determined based on an identification of computing resources required to process the task. A subset of the computing resource pool is allocated to execute the task based on the DNN configuration. A selected set of DNN blocks from the DNN repository is activated based on the DNN configuration, and a device transmit input data to the subset of the computing resource pool to execute the task via the selected set of DNN blocks.

### RELATED APPLICATION

This application claims the benefit of U.S. Provisional Application No. 63/564,937, filed on Mar. 13, 2024. The entire teachings of the above application are incorporated herein by reference.

### GOVERNMENT SUPPORT

This invention was made with government support under Grant Nos. OAC-2201536 and CNS-2312875 awarded by the National Science Foundation, Grant No. FA9550-23-1-0261 from the Air Force Office of Scientific Research, and Grant No. N00014-23-1-2221 from the Office of Naval Research. The government has certain rights in the invention.

### BACKGROUND

Computer vision (CV) mobile applications often require operation with Deep Neural Networks (DNN) to execute. DNNs are computationally and memory intensive to be trained and deployed. However, due to their design limitations, mobile devices may be unsuitable for hosting hardware and energy storage that meet the DNNs requirements for supporting CV tasks in a timely manner. To address this issue, conventional approaches resort to task offloading, wherein mobile devices, connected to an edge server through a radio link, delegate the processing of a CV task to the relatively more powerful edge computing platform.

### SUMMARY

Example embodiments include a system for distributing tasks. A computing resource pool may include computer hardware configured to execute tasks. A deep neural network (DNN) repository may comprise a plurality of DNN models. A controller may be configured to: 1) receive a request to process a task from a device across a network, 2) determine a DNN configuration to process the task based on an identification of computing resources required to process the task, 3) allocate a subset of the computing resource pool to execute the task based on the DNN configuration, 4) activate a selected set of DNN blocks from the DNN repository based on the DNN configuration, and 5) enable the device to transmit input data to the subset of the computing resource pool to execute the task via the selected set of DNN blocks.

The controller may determine the DNN configuration by: 1) applying the task to a graph model representing a plurality of solution paths through a DNN structure, and 2) identifying a path of the plurality of solution paths, the path traversing a representation of the selected set of DNN blocks corresponding to the DNN configuration.

The path may be identified based on an indication of required computing resources to execute the task via the path. The path may also be identified based on a task admission ratio indicating a likelihood of the task being admitted for execution. The path may be unassociated with unselected blocks from the DNN repository. The graph model may comprise a plurality of nodes connected by links, the nodes each representing a decision to be made by the selection of DNN blocks. Each of the plurality of nodes may have attributes indicating required computing resources to execute the decision at the node. The controller may be further configured to determine the required computing resources for the path based on the attributes of each node comprising the path.

The controller may be further configured to construct a dynamic DNN to execute the task, the dynamic DNN comprising the selected set of DNN blocks. The dynamic DNN may comprise layers extracted from a plurality of different DNN models of the DNN repository. Each of the subset of DNN blocks may be one or more layers of the plurality of DNN models. The controller is further configured to allocate a transmission slot based on the DNN configuration, the transmission slot defining the transmission of the input data from the device to the selected set of DNN blocks.

Further embodiments include a method of distributing tasks. A request to process a task from a device across a network may be parsed. A deep neural network (DNN) configuration to process the task based on an identification of computing resources required to process the task may be determined. A subset of a computing resource pool may be allocated to execute the task based on the DNN configuration, the computing resource pool including computer hardware configured to execute tasks. A selected set of DNN blocks from a DNN repository based on the DNN configuration, the repository comprising a plurality of DNN models. A selected set of DNN blocks from a DNN repository may be activated based on the DNN configuration, the repository comprising a plurality of DNN models. The device may then be enabled to transmit input data to the subset of the computing resource pool to execute the task via the selected set of DNN blocks.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-C are diagrams depicting distinct scenarios of image classification in example embodiments.

FIGS. 2A-B are graphs comparing different DNN block training configurations in one embodiment.

FIGS. 3A-B are charts comparing effects of applying pruning on different DNN layer-blocks in one embodiment.

FIG. 4 is a diagram illustrating the architecture and workflow of a DNN network in an example embodiment.

FIG. 5 depicts a formulation of a DNN for scalable Offloading of Tasks (DOT) problem in one embodiment.

FIG. 6 depicts a decision tree in one embodiment.

### DETAILED DESCRIPTION

A description of example embodiments follows.

Resource availability at the edge, even if larger than at the mobile devices, is still limited. Conventional approaches do not consider memory consumption of DNNs as a limiting factor to the execution of tasks at the edge. Further, the structure of the DNNs required for the execution of different CV inference tasks, and the correlation among such structures, has been overlooked, thus failing to exploit the benefits that instead accounting for such factors can bring. In example embodiments, carefully shaping and sharing the DNNs, i.e., acting on which blocks of DNNs layers are used for different CV tasks, increases the number of tasks admitted for execution at the edge, while reducing resource consumption compared to the state of the art, thus scaling very well with the diversity and number of tasks.

Joint task admission and layer configuration and sharing among different DNNs are highly challenging. This is because (i) the required DNNs depend on the offloaded tasks that can be admitted at the edge and, more specifically, on the required CV methods and object classes; (ii) the available configurations must consider the requirements of admitted tasks and the available resources; (iii) sharing is feasible only when two or more DNNs have a sequence of common layers, which requires freezing such layers during DNN training and fine-tuning the remaining task-specific layers. Additionally, the relationship between admitted task latency and accuracy and the DNN structures is highly nonlinear and cannot be expressed in closed form, which further complicates the issue of DNN shaping and sharing.

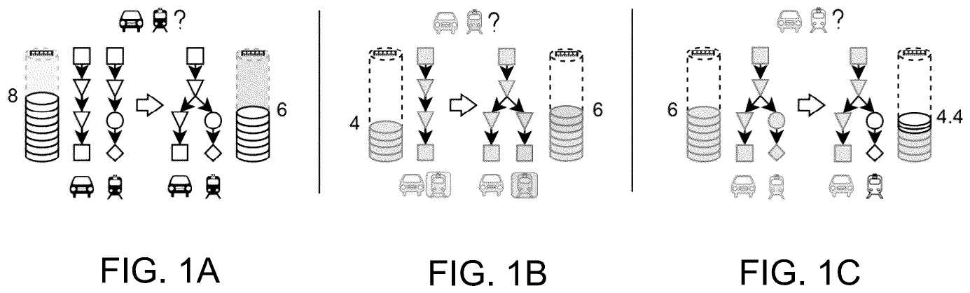

FIGS. 1A-C are diagrams depicting distinct scenarios of image classification. To optimize the consumption of radio and compute resources, while respecting the requirements of the offloaded tasks, example embodiments provide a new framework for scalable Offloading of DNN tasks. In this framework, hidden layers of a DNN specialize in different feature levels. The initial layers detect low-level features such as corners, edges, and colors, and, as we move towards the final layers, they become specialized in detecting high-level features such as items, scenes, patterns. While high-level features are task-specific and not ideal for tasks other than the one they have been originally trained on, lower-level features can instead be common among different tasks.

FIG. 1A depicts a DNN block-sharing scenario for classifying images of different objects such as a car and a train as shown. At left, the DNN employs separate blocks for the classification of trains and cars. At right, the DNN shares a subset of blocks for classification of both trains and cars. Thus, DNN layers can be shared at the edge among DNNs serving different offloaded tasks, thereby saving memory while still offering acceptable DNN accuracy.

While DNN layers trained for the most common CV tasks can be used for a variety of applications (i.e., they can be easily shared), they may be inadequate for other tasks for which they have not been specifically trained. In these cases, fine-tuning task-specific layers, although costly, can improve the level of accuracy attained for such tasks, and, at the same time, freezing the initial, general-purpose layers still allows them to be shared and help mitigate the well-known issue of catastrophic forgetting. As shown in FIG. 1A, a DNN can be tailored as to which layers to share among different tasks and which layers to fine-tune, depending on the tasks requirements. In so doing, we can effectively trade off training cost with tasks accuracy.

Moreover, when an already-available DNN is accurate enough, we allow for structured pruning of (all or some of) the DNN layers to decrease the compute and memory footprint needed for inference execution while still offering acceptable accuracy. As depicted in FIG. 1C, blocks of DNNs layers can be pruned to decrease resource consumption and inference latency, while still meeting accuracy requirements.

Example embodiments may be built on a mathematical formulation of the problem of DNN for scalable Offloading of Tasks (DOT) to find (a) the optimal composition of (possibly pruned and fine-tuned) blocks of DNNs layers, (b) the set of offloaded tasks that can be admitted at the edge, and (c) the allocation of (radio and computing) resources for tasks remote execution. DOT minimizes the task rejection rate and resource consumption, while meeting the accuracy and latency requirements of admitted tasks. The DOT problem is fundamentally different from the existing formulations as, for all admitted tasks, it considers different configurations of the DNNs that can serve for the execution of the inference tasks, with each configuration offering different opportunities for sharing layers with other DNNs and leading to different performance-resource consumption tradeoffs.

Example embodiments provide a framework supporting scalable offloading of CV tasks to the edge, to allow for the solution of realistic instances of the DOT problem. They implement an efficient heuristic based on weighted tree-based graph modeling of the feasible solutions, which accounts for DNN layers sharing, hence the possible correlation in memory utilization among the DNNs deployed to handle the admitted inference tasks.

Example embodiments can be evaluated through a comprehensive numerical analysis and leveraging a proof-of-concept prototype implemented on the Colosseum network emulator, by considering real-world CV tasks and state-of-the-art DNNs. Example results show that, in small-scale scenarios, embodiments perform very closely to the optimum. In large-scale scenarios, it allows for more offloaded tasks and substantial resource savings compared to a conventional approach, while consistently meeting task constraints.

Task offloading can requires optimizing both radio resources and edge computational resources. Indeed, task input data acquisition for inference execution (and transmitting back the results to mobile devices) may require optimal usage of radio resources. Also, besides the memory taken by the deployed DNNs, fine-tuning the DNN architectures for specific CV tasks and compressing them before deployment and performing inference on the offloaded data require significant computational effort from CPUs and GPUs of edge servers. Two experiment-driven motivating factors support the value of example embodiments. The first one is related to optimizing the training expense of DNN models for specific tasks while converging to target performance. The second is related to optimizing inference compute time while deploying a DNN in a resource-constrained edge server.

Before deploying a DNN for a specific task, a first step is to train the model parameters efficiently. Training a DNN from random initialization of the parameters results in slow convergence up to a target accuracy. Thus, training a new DNN from scratch for each task is not always the best solution. Alternatively, fine-tuning a pre-trained DNN with a new task-related dataset may be a better approach. If the new dataset is similar to the pre-training dataset, we can freeze the early layers of the DNN while preserving the learned features from the larger dataset.

TABLE 1
DNN Block Configurations

| Name | Description |
|---|---|
| CONFIG A | Entire DNN structure trained from scratch |
| CONFIG B | First 4 layer-blocks shared from the base DNN |
| CONFIG C | First 3 layer-blocks shared. Last layer- |
| | block + classifier layers fine-tuned |
| CONFIG D | First 2 layer-blocks shared. Last 2 layer- |
| | blocks + classifier layers fine-tuned |
| CONFIG E | First 1 layer-blocks shared. Last 3 layer- |
| | blocks + classifier layers fine-tuned |
| CONFIG A-pruned | CONFIG A DNN architecture with pruning ratio |
| | 80% |
| CONFIG B-pruned | CONFIG B + Fine-tuned layer-blocks are |
| | pruned with ratio of 80% |
| CONFIG C-pruned | CONFIG C + Fine-tuned layer-blocks are |
| | pruned with ratio of 80% |
| CONFIG D-pruned | CONFIG D + Fine-tuned layer-blocks are |
| | pruned with ratio of 80% |
| CONFIG E-pruned | CONFIG E + Fine-tuned layer-blocks are pruned |
| | with ratio of 80% |

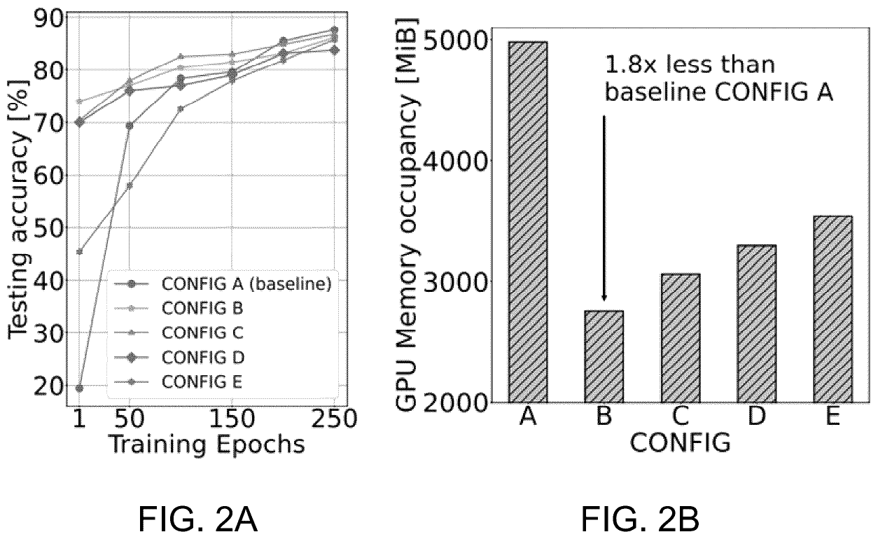

FIG. 2A is a graph comparing the training costs of various DNN configurations as listed in Table 1, and refers to the training of an example feature extractor. The DNN was initially trained on a subset of a dataset (Table 2), featuring 60 object categories. These are the pre-trained parameters that form the backbone for the configurations in Table 1. Subsequently, these DNN configurations may be trained using a new dataset that contains an additional object class. For fair comparison between all the configuration training, we use batch size of 256, ‘Adam’ optimizer, ‘CosineAnnealing’ learning rate scheduler, starting learning rate of 0.2, decay rate of 0.001, Cross-Entropy as loss function. In this experiment, we emulate the fact that a new task is to detect grocery items (e.g., mushrooms). To reach near 80% testing accuracy, CONFIG A takes more than 200 training epochs, while CONFIG B and CONFIG C converge to 80% accuracy faster. Further, CONFIG C outperforms CONFIG D and CONFIG E, which share and freeze fewer layers than CONFIG C.

TABLE 2
Base Datasets

| Objects | Description |
|---|---|
| Vehicle | 12 vehicle categories(e.g., Bus) |
| Wild animals | 18 wild animal categories(e.g., koala) |
| Snakes | 10 snake categories(e.g., green snake) |
| Cats | 6 cat categories (e.g., Persian cat) |
| Household Objects | 14 household objects (e.g., toaster) |
| Total | 60 categories of objects |

In FIG. 2B, it is important to notice the reduced GPU memory occupancy by CONFIG B and CONFIG C compared to the other configurations, which indicates that the shared layer-blocks are not using processing resources to train the model parameters. Eventually, after more than 250 epochs, the fully fine-tuned CONFIG A configuration achieves better accuracy than the shared configurations. On the contrary, CONFIG B and CONFIG C models get overfit to the training data after long training epochs and achieve lower accuracy than CONFIG A baseline. Similarly, CONFIG D and CONFIG E converge more slowly to 80% accuracy than CONFIG C. The reason is that both of the DNN structures have more parameters to train during the training process compared to CONFIG C. Thus, example embodiments can be optimized for acceptable accuracy according to task demand with shared configurations with less training cost, or we can fully fine-tune DNN parameters for better performance.

Using DNNs containing millions of parameters tends to be costly in terms of computational resources. This motivates reducing the number of parameters to make the DNN more compact to deploy in a resource-constrained edge computing scenario. To this end, DNN pruning is a very popular method to alleviate the over-parameterization while maintaining the accuracy of the original DNN. General pruning steps start with training the larger network, then applying the pruning criterion on the model, and then fine-tuning the smaller network again. This iterative process goes on until a satisfactory sparsity level and model performance is reached. In the recent literature, authors argue against iterative pruning considering fine-tuning budget limitations in a resource-constrained scenario. To save time and effort for this iterative pruning, single-shot pruning methods are getting popular.

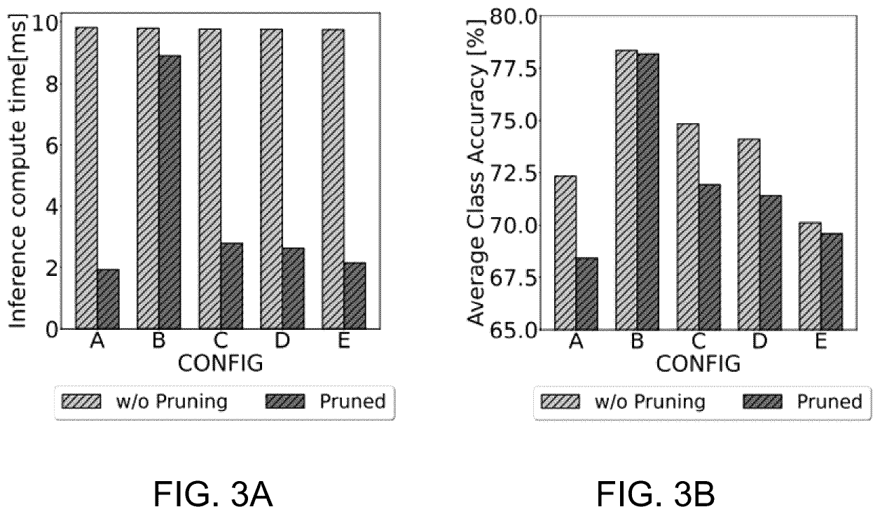

FIGS. 3A-B are charts comparing the effects of applying pruning on different DNN layer-blocks with feature extractor architecture and configurations listed in Table 1. It can be demonstrated that pruning DNN blocks after fine-tuning for the target task will greatly reduce the inference compute time on the edge server, with a potential risk of degrading performance. We use the same configurations as listed in Table 1 with a feature extractor and apply pruning after 100 epochs of fine-tuning for a new task to detect ‘Musical Instruments’ from the data set. To make a fair comparison between different configurations, we choose 100 epochs of fine-tuning and a constant pruning ratio of 80% for the training phase. After fine-tuning, we apply magnitude pruning to the fine-tuned layer-blocks only, as shared layer-blocks are to be used for other tasks in hand. FIG. 3A shows the results of inference compute time for a dummy input tensor of each configuration compared to the non-pruned version of it. It is evident that the CONFIG B-pruned has a smaller inference compute time difference compared to other configurations. Due to four shared layers-blocks from the base model, the CONFIG B-pruned DNN has the least number of pruned blocks, hence, larger amount of parameters, and it takes longer to infer an input. For the same reason, the CONFIG C-pruned, CONFIG D-pruned and CONFIG E-pruned DNNs take less and less time than the CONFIG B-pruned DNN. Smallest inference compute time is found with CONFIG A-pruned, compared to its baseline CONFIG A, mostly because the entire DNN was fine-tuned and pruned for task-specific purposes.

FIG. 3B depicts the average class accuracy of a specific object to be detected (in this case it is “Electric guitar”) for all the configurations and their pruned versions. After pruning, each of the configurations performs a bit worse compared to its original version. In this case, CONFIG B, shows better performance after pruning because most of its layer-blocks are inherited from the base DNN model. Further fine-tuning from this stage of the pruned model may increase the accuracy of all the configurations, but it will also increase the training expense. Thus, to minimize the inference compute time of CV tasks at the edge, we can choose among different pruned configurations depending on the trade-off they offer between accuracy and inference compute time. Alternatively, a DNN configuration without pruning can be selected if task requirements are particularly accuracy-intensive.

In view of the above, it is evident that selecting the best DNN model for task requirements is not a straightforward problem that can be solved with simple heuristics. Rather, it is a complex problem that involves multiple intertwined factors.

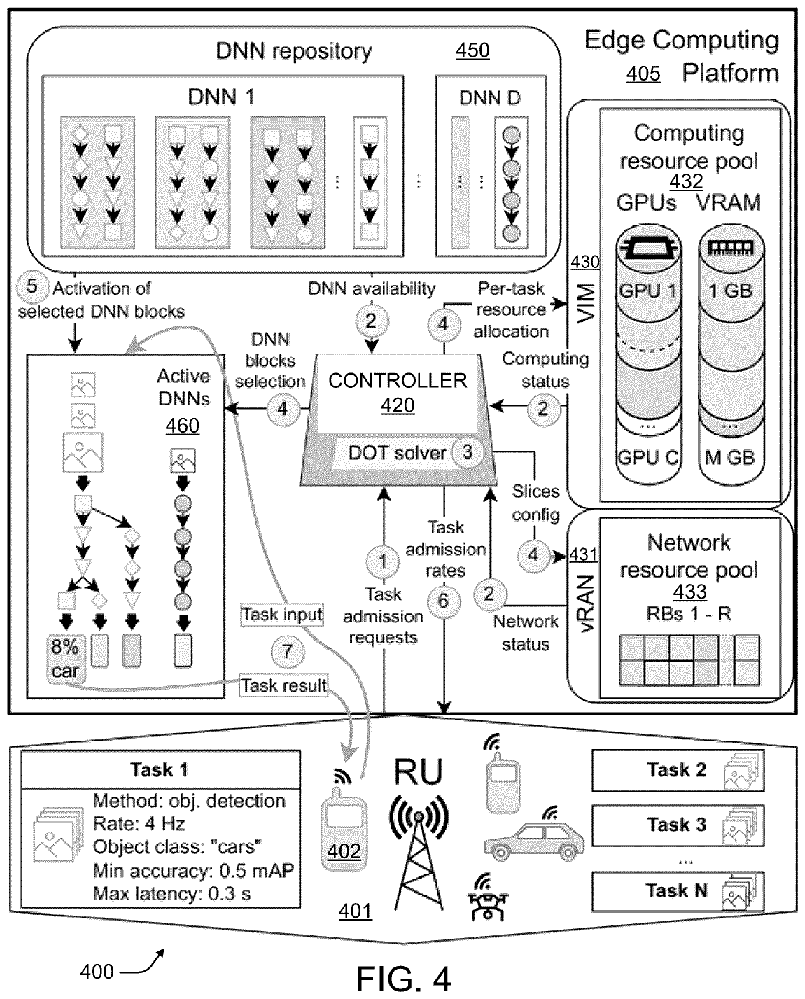

FIG. 4 is a diagram illustrating the architecture and workflow of a DNN network 400 in an example embodiment. In the scenario shown, mobile devices connected to a wireless network 401, such as the mobile device 412, can benefit from offloading CV tasks to an edge computing platform 405 connected with the base station covering the devices. As the edge platform 405 has limited resource capacity, it has to determine which tasks to admit and how to serve them.

### Reference Model

In one example, let T be a set of Tinference tasks, with each TET representing a CV method that can be implemented through a DNN out of a set, D, of available models, to be applied to the images generated by the mobile devices. Examples include image classification performed through neural networks such as ResNet-18 or MobileNetv2. Each task τ is associated with a minimum required accuracy, A_{τ} (e.g., mean average precision for an object detection task), and a maximum end-to-end latency Lᵣ, accounting for both networking and processing latency. A task is also associated with priority p_{τ}, which is a real value between 0 (lowest priority) and 1 (highest priority) indicating the importance of a task, and a request rate λ_{τ}, which specifies the number of images over which the inference task is requested per second.

To offload tasks, a mobile device 402 may submit task admission requests to the controller 420, which runs the DOT problem solver (1). In addition to the tasks definition, the DOT solver may receive as input the available DNN blocks of the DNN repository 450 and their resource cost, and the available computing and radio resources capacity of the computing resource pool 432 and network resources pool 433, which are pulled from the Virtual Infrastructure Manager (VIM) 430 and the vRAN 431 (2). After obtaining the DOT solution (3), the controller 420 allocates the radio slice and the computing resources at the resource pools 432, 433 (4), and deploys the selected DNN blocks as active DNNs 460 for the soon-to-be-admitted tasks (5). Then the controller 420 notifies the mobile device 402 about the admitted tasks rates (6). The mobile device 402 may then transmit task input data and receive task results via the active DNNs 460 (7).

A task τ can be offloaded by mobile devices to an edge server using a radio network slice specifically allocated for the task. The number of resource blocks (RBs) allocated to a slice, r_{τ}, for task τ may vary over time but the sum for all admitted tasks requests cannot exceed the available capacity R (expressed in RBs). Also, denoting with σ_{τ} the average signal-to-noise ratio (SNR) experienced by mobile devices offloading task τ over the allocated radio network, we define B(σ_{τ}) as the number of bits that a single RB can carry.

An offloaded task is executed by a dynamic DNN structure, d, which is built using blocks s^{d}∈S^{d}. Such blocks can represent one or multiple layers of a DNN, or versions thereof pruned by an arbitrary factor. The sequence of blocks in S^{d} selected to serve task τ is identified by the path on the DNN structure:

$${π}_{τ}^{d} = {[ {s}^{d} ]}_{d} ∈ {\prod }_{τ}^{d}$$

Training or fine-tuning the DNNs blocks has a computational cost (CPU/GPU time in seconds); also, let c(s^{d}) and μ(s^{d}) be, respectively, the inference computing time and the utilized memory, associated with block s^{d}, which can be derived experimentally. The fundamental difference between how computing time and memory utilization associated with active DNN blocks consume the available edge resources is that, for every offloaded task, computing time increases proportionally with the task rate, while memory utilization remains constant.

According to the task context (e.g., image lighting conditions or camera sensor resolution), a quality level q_{τ}∈Q_{τ} is associated with the task and determines the achievable accuracy level a_{τ}, derived again experimentally due to its high non-linearity with respect to the image quality and the processing path on the DNN:

$${pi}_{τ}^{d}$$

The quality level also determines the number of bits per image, β(q_{τ}), to be transmitted over the radio link from the device offloading task τ to the edge.

A task experiences end-to-end latency, including both networking and processing components, defined as:

$${l}_{τ} ( {q}_{τ} , {r}_{τ} , {σ}_{τ} , {y}_{{π}_{τ}^{d}} , c ( {s}^{d} ) ) = \frac{b ( {q}_{τ} )}{B ( {σ}_{τ} ) \cdot {r}_{τ}} + {\sum }_{{s}^{d} ∈ {π}_{τ}^{d}} c ( {s}^{d} )$$

Where the networking component is the transmission time of β(q_{τ}) bits over a link of capacity B(σ_{τ})·r_{τ}, and the processing one is given by the sum of processing times of the DNN blocks that belong to the selected path π^{d}. Finally, the computational resource capacity that the edge server can devote to offload tasks is limited to C and M, indicating, respectively, the available compute time (CPU/GPU time in seconds) and memory (RAM/VRAM in GB).

The notations used herein are summarized in Table 3, below.

TABLE 3
Notation

| Symbol | Description |
|---|---|
| [symbol] ∈ [symbol] | Requested tasks, with \| [symbol] \| = T |
| d ∈ [symbol] | Set of possible dynamic DNN structures, each able |
| | to serve multiple tasks |
| s^{d} ∈ [symbol] ^{d} | Block belonging to the dynamic DNN structure d |
| p_{τ} | Priority of task [symbol] |
| π_{τ}^{d} ∈ Π_{τ}^{d} | Sequence of blocks [s^{d}]_{d} belonging to the dynamic |
| | DNN structure d, suitable for executing task [symbol] |
| λ_{τ} | Request rate of task [symbol] |
| A_{τ} | Minimum accuracy tolerable for task [symbol] |
| L_{τ} | Maximum latency tolerable for task [symbol] |
| [symbol] _{τ} | Set of auxiliary variables denoting the possible |
| | quality levels for the data that are input to task [symbol] |
| R | Number of available RBs |
| C | Available compute time (CPU/GPU) |
| M | Available memory (RAM/VRAM) |
| σ_{τ} | SINR of mobile devices requesting task [symbol] |
| B(σ_{τ}) | No. of bits carried by an RB assigned to a mobile |
| | device generating data for [symbol] |
| β(q_{τ}) | No. of bits associated with transferring data with |
| | quality level q_{τ} as input to task [symbol] |
| c(s^{d}) | Compute time required by block s^{d} |
| μ(s^{d}) | Memory required by block s^{d} |
| cₜ (s^{d}, •) | Cost of training s^{d} |
| x_{τ}^{d} | Binary decision variable taking on 1 when DNN type |
| | d is used for task [symbol] |
| y_{π}_{_{τ}}^{d} | Binary decision variable, taking on 1 when π_{τ}d is |
| | selected for task [symbol] |
| z_{τ} | Real-valued decision variable representing the task |
| | requests admission ratio |
| r_{τ} | Integer decision variable indicating the no. of RBs |
| | assigned to mobile devices offloading task [symbol] |
| m(s^{d}) | Binary auxiliary variable, indicating whether s^{d} is |
| | used by at least one task |

### DOT Formulation

First, the following decision variables may be considered:
the task admission vector z=[ [symbol] ₁, . . . , [symbol] ₂] where [symbol] _{τ}∈[0, 1] indicates the fraction of task τ request rate that is admitted for offloading;
the task-DNN mapping vector x^{d}=[x₁^{d}, . . . , x_{T}^{d}], ∀d∈ [symbol] , where [symbol] is a binary variable indicating whether task τ is served by the DNN d or not;
the DNN path selection vector y_{π}_{^{d}}=[y_{π}_{₁}_{^{d}}, . . . y_{π}_{_{T}}_{^{d}}], ∀d∈ [symbol] and path on d, where y_{π}_{_{τ}}_{^{d}} is a binary variable that takes on 1 if [symbol] is used to execute task [symbol] ;
the radio resource allocation vector r=[r₁, . . . , r_{T}] where r_{τ} is the number of RBs allocated for offloading task τ.

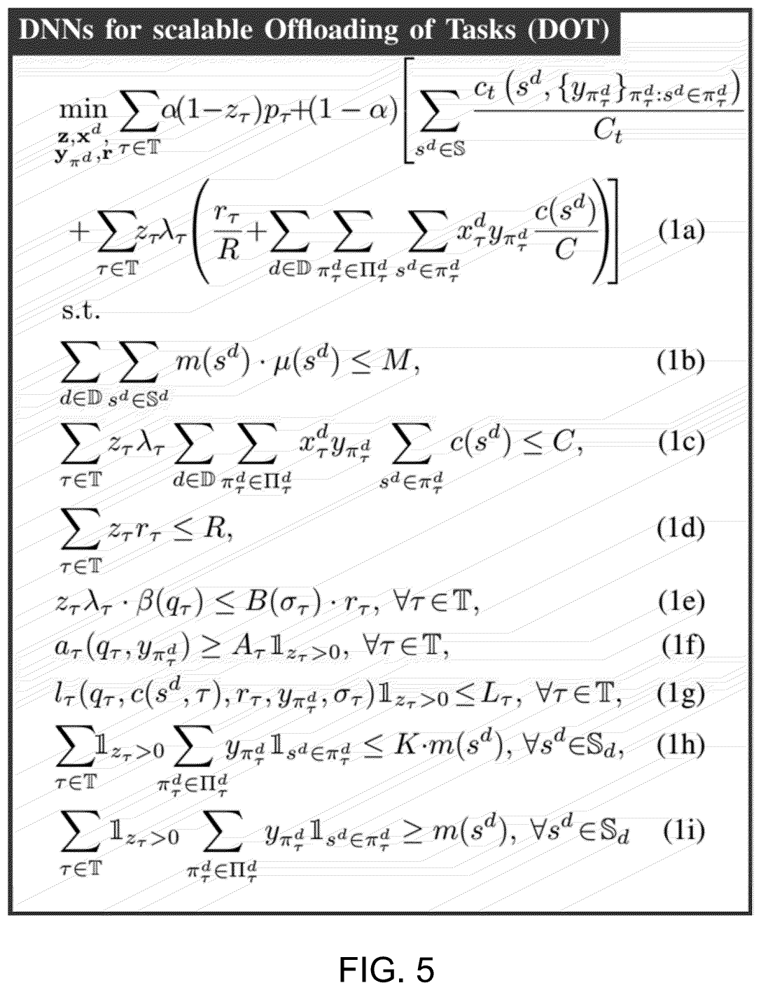

FIG. 5 depicts a formulation of the DOT problem. One goal of the DOT problem is to minimize the rejection rate of the tasks (also accounting for their priority), the cost of the radio resources for offloading the admitted tasks, and the cost of the edge resources for both training and inference of the DNNs deployed to handle such tasks. Thus, the DOT problem can be formulated as shown in FIG. 5, where the objective function (1a) weights by parameter a the task admission term and the resource allocation term. More specifically, the latter accounts for: (i) the cost of training each block s^{d}∈S that is selected for serving one or multiple admitted tasks normalized to the full DNN training cost (for brevity, we denote with S the set of all possible blocks of all available DNNs); (ii) the fraction of total radio resources allocated for offloading the admitted tasks, and (iii) the cost of CPU/GPU time consumed by each DNN block to execute inference for the admitted tasks, normalized to the cost yielded by the full DNN. The training cost (cₜ) of a block s^{d} also depends on the subset of tasks that will use that block (represented through the decision variables y_{πd}), thus accounting for the possible savings that sharing a block among different tasks can bring. Also, such a cost is zero when no task makes use of s^{d}. Further, both the training (cₜ) and inference (c) costs can be computed off-line; hence, given the set of tasks T and possible subsets thereof, the values of such costs are inputs to the DOT problem.

Computing resource budget requirements are enforced by (1b) for the memory and (1c) for the CPU/GPU time, which ensure that they do not exceed the available capacity. We remark that, whenever multiple tasks use the same DNN block s^{d}, the memory utilization due to s^{d} is counted only once; this is done by introducing the binary auxiliary variable m(s^{d}), which takes 1 when s^{d} is used by at least one task. Conversely, the consumed compute time is summed over all tasks using DNN block s^{d}, scaled according to the admission task rate [symbol] ·λ_{τ}. Similarly, the requirements related to the radio resources are expressed by (1d) and (1e). The former ensures that the number of RBs assigned to the radio network slices serving a task does not exceed the available capacity. The latter imposes that each task is allocated a radio slice that has sufficient bandwidth to transmit task input data of quality q_{τ} generated by the mobile device experiencing channel quality σ_{τ}, given the selected admission task rate z_{τ}·λ_{τ}.

Task requirements compliance is enforced by constraints (1f) and (1g). Notice that ]_{zτ>0} is an indicator function that takes on 1 if [symbol] >O. In (1f), the accuracy function associated with task τ must comply with the minimum accuracy requirement A_{τ}, as long as tasks τ are admitted with a non-zero ratio z_{τ}. Similarly, in (1g), for every task with a non-zero admission ratio, the maximum tolerable end-to-end latency must be satisfied by the task latency function. Finally, (1h) and (1i) are used to force the values of the auxiliary binary variable m(s^{d}). Here, [symbol] s^{d}∈π_{τ}^{d}

is an indicator function taking 1 when DNN block s^{d} is part of path π^{d}. More in detail, (1h) uses the Big M method notation (here, K takes a large value) to force m(s^{d}) to take 1 when s^{d} is used by at least one task. Conversely, according to (1i), m(s^{d}) must take 0 when s^{d} is not used by any task.

The above formulation supports the conclusion that the DOT problem is NP-hard. Proof of this conclusion is based on a reduction in polynomial time from the binary multi-dimensional knapsack problem, which is known to be NP-hard. Although the DOT formulation has been given considering no preexisting DNNs already deployed at the edge for previously admitted tasks, it can be trivially extended to deal with a dynamic scenario where new tasks offloaded by mobile devices may need to be incrementally accommodated at the edge server. In this case, it is indeed enough to consider the training cost and memory occupancy of already-deployed DNN blocks equal to zero, discount the radio, compute, and memory capacity, and only account for the additional blocks and RBs that may be needed by the set of newly requested tasks.

### Offloading of Tasks in Example Embodiments

In light of the NP-hardness of the DOT problem described above, example embodiments provide for serving inference tasks through efficient sharing and configuration of dynamic DNN structures. The fundamental aspects and the challenges of the DOT problem include:

Size of the solution space: The solution space, especially concerning integer optimizing variables, includes the various permutations of DNN paths for different tasks, which is very large. Solving the DOT problem thus demands a method to explore and evaluate potential solutions efficiently while still being able to make high-quality decisions.

Accounting for heterogeneous resources: The DOT problem deals with cost and allocation of resources that are diverse, in terms of both type and dimensionality, which need to be considered and effectively utilized in the solution.

DNN block sharing among different inference tasks: The DOT problem involves choosing the best DNN blocks sequence (i.e., paths) for the offloaded tasks, where these paths share memory resources and training costs. Achieving efficiency in terms of total memory utilization and training cost requires considering the fact that DNN blocks can be shared by different tasks and accounting for such possible correlations while selecting the optimal paths for the various tasks.

In example embodiments, the characteristics and challenges of DOT can be addressed as follows:

Graph-based model: The problem of complexity can be addressed by modeling the solution space through a graph that is built by processing the tasks sequentially (instead of in parallel) according to their priority level, from highest to lowest. Each vertex then represents a possible decision for a task, i.e., a path on a dynamic DNN structure that can be used for that task execution, and edges connect different deployment options when transitioning between tasks. To reduce the solution space and explore it in an efficient manner, upon processing a new task, only the vertices corresponding to feasible solutions, i.e., honoring accuracy and inference latency constraints, are included.

Assigning attributes to vertices: Vertices carry multidimensional and heterogeneous attributes capturing the diverse nature of the resources to be allocated: total memory consumption, training and inference compute time, and radio resource allocation for data transfer. Additionally, attributes represent the task admission ratio, and the accuracy and latency associated with a given path. Attributes also provide flexibility in modeling the system, in that their values can vary in dynamism: they can be fixed, dynamic, or subject to optimization upon graph traversal.

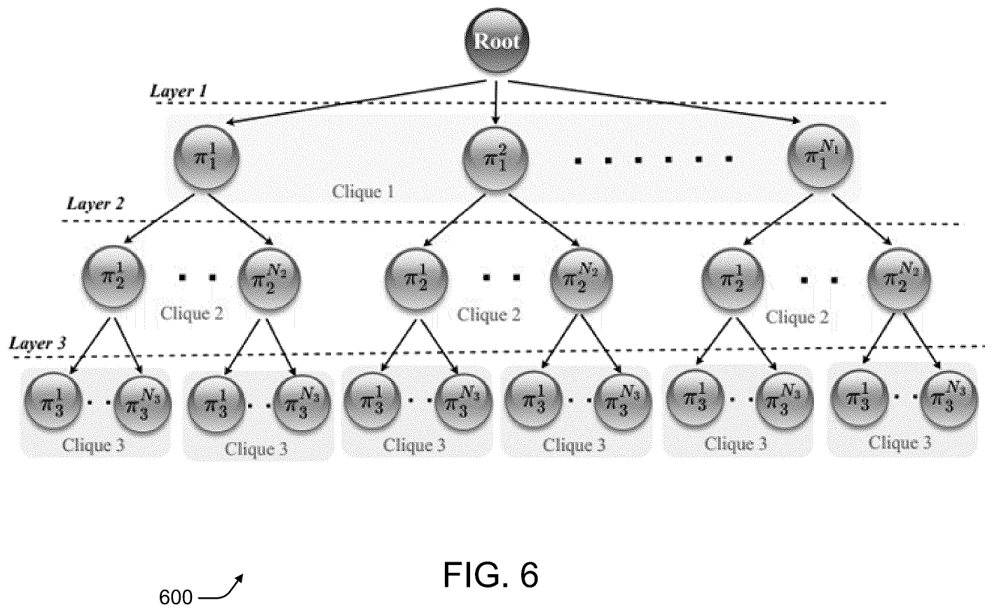

Tree structure: The graph built in example embodiments may have a tree structure, with each layer corresponding to the decisions that are possible for a given task, from the highest-priority task to the lowest-priority one (the tree root represents the process starting point). Every layer accommodates “sibling” groups of vertices, i.e., groups of vertices that are replicated almost the same but for the value taken by the total memory utilization and the training cost attributes. The group of siblings at layer t is referred to as clique t (FIG. 6, described in further detail below). Each repetition of a clique connects to a single parent vertex, enabling us to track the dependencies of memory and training cost from previously selected paths during graph traversal (i.e., the choices concerning the higher-priority tasks). Indeed, the vertex total memory consumption and training cost attributes update dynamically during traversal. Further, by properly ordering the vertices within each clique according to their inference compute time, we dramatically reduce the complexity of tree exploration by selecting the tree branch that minimizes this metric.

FIG. 6 depicts an example hierarchical tree representation for T=3 tasks. Here, task τ=1 has highest priority with N₁ siblings in clique 1, τ=2 has second highest priority with N₂ siblings in clique 2, and τ=3 has third highest priority with N₃ τ siblings in clique 3. Each vertex vⱼ in the clique at t-th layer corresponds to a possible path on a DNN that can serve the task of priority t.

To construct a tree, a directional tree T=(V, E) may be defined wherein each vertex, vᵢ∈V, models a possible DNN configuration (path) for the execution of a task. The set of edges E represents directional connections, from parent to child vertices. The tree has T=|T| layers: each layer in T corresponds to a specific task τ, with the sequence of layers from root to leaves matching the descendent order of the tasks priority.

Each layer is constructed by replicating a group of vertices referred to in FIG. 6 as a clique: All vertices within a clique share the same parent and represent suitable DNN paths for that specific task. Within each clique, we arrange vertices {vᵢ} from left to right based on the increasing inference compute time of the DNN paths represented by the vertices.

At a given layer, different cliques differ by the value taken by the total memory utilization attribute and the associated training cost. Given |D| DNNs suitable for task τ of priortiy t, with each DNN d offering

N_{d}=|Π [symbol] ^{d}|

potential paths, a clique for task τ involves aggregating

N_{τ}= [symbol] N_{d}

vertices, with the j-th vertex representing a DNN path, i.e.,

vⱼ= [symbol] .

These vertices encapsulate information about the utilized DNN blocks, their characteristics, and their cost. Specifically, each vertex embodies static, dynamic, and to-be-optimized attributes. The static attributes of a vertex include the attained accuracy a_{τ}, inference latency l′_{τ}, required computational time by the inference task

[symbol]

c(s^{d})

and number of bits β(q_{τ}) to be transmitted over the radio interface from the mobile device providing the edge with the input data for the task with quality q_{τ}. The variable attributes are the total memory consumption and associated training cost attributed to the corresponding blocks for the tasks processed till this tree layer. The attributes to optimize include task admission ratio z_{τ} and resource block allocation r_{τ}, which are initialized to 1 during the tree construction phase.

Edges e∈E link each vertex within a layer to all vertices in the subsequent task's clique, maintaining task priority order. This creates a complete tree structure comprising [symbol] vertices; thus, traversing all vertices proves computationally challenging. To manage complexity, at every layer, vertices violating the accuracy constraint or associated with an inference compute time greater than L_{τ} are removed.

Each branch within the tree, denoted by bₖ, comprises vertices corresponding to distinct layers, ensuring that each branch contains a single vertex representing a specific DNN path (i.e., configuration option) for a task τ from layer t. Each branch holds records of attributes associated with the vertices traversed in that branch, as detailed below.

Tree Traversal: We define the cost function representing the total cost associated with a tree branch as the DOT objective function in (1a) (FIG. 5). In so doing, the optimal solution can be found by selecting the least-cost branch. Traversing the tree to compute the branches cost involves employing a Depth-First Search (DFS) approach to track branch costs and update the dynamic attributes of the vertices within each branch.

More specifically, while traversing the vertices of a branch bk, the memory consumption and training cost at each subsequent vertex

vⱼ=

[symbol]

at layer t and task τ are updated, considering the additional costs incurred by employing new blocks {s^{d}} compared to those used by the preceding vertices within the same branch up to layer t−1. If the memory consumption exceeds the threshold M at any vertex on a branch bₖ, exploration of that branch halts. Thus, after exploring all branches, the cost for each branch can be computed by solving an optimization problem with (i) the objective function as in (1a) but with

[symbol]

, [symbol] ,

[symbol]

given (the latter are the vertices on the considered branch); (ii) the constraints are as in (1c)-(1e) and (1g), because while building the tree we already made sure that those related to memory, accuracy, and latency were honored. Finally, the branch with the least cost, denoted by b*, provides the optimal task admission ratio z*τ and resource allocation r* [symbol] . Within this branch, the vertex information at layer t identifies the optimal DNN d and the corresponding DNN path for task τ, implying that

[symbol]

=1 and [symbol] =1.

In this new optimization problem, the objective function is a linear combination of known constants and decision variables z_{τ} and r_{τ}. The first two and the fourth constraints are linear and, hence, convex. The third constraint involves linear combinations of z_{τ} and r_{τ}. Also, B(σ_{τ}) is positive and b(q_{τ}) is a convex function. Hence, the problem is convex in z_{τ} and r_{τ} and can be solved to the optimum by using any convex optimizer. Nevertheless, the above solution strategy has exponential complexity, namely

[symbol]

(Nₘₐₓ^{T}T²)

Indeed, the possible number of vertices in a clique is

[symbol]

| [symbol] |

Thus, the total number of vertices in T is at most

Nₘₐₓ= [symbol] [symbol] ]| [symbol] |

Also, the worst case complexity for solving the linear optimization problem for z_{τ} and r_{τ} with 2(T+1) constraints and maximum 2T variables for a branch is

[symbol]

(4T×(T+1))

Example embodiments can therefore leverage the method followed while constructing the tree (i.e., the fact that at each layer vertices appear in increasing order with regard to their inference compute time), and, while traversing the tree from the root to the leaves, the first branch may be selected. The rationale is that, in (la), the total inference cost is minimized when the corresponding compute time of all tasks is minimal. Notably, though the inference compute cost of the branches increases from left to right, the value of the DOT objective function may not follow the same trend, as it includes further terms. However, example embodiments may then exhibit a polynomial, and indeed dramatically reduced complexity, namely, O(T²), at the expense of achieving a suboptimal solution.

Example embodiments address the problem of executing multiple computer vision tasks offloaded by mobile devices to the edge. In so doing, three features may be leveraged: (1) a proper set of DNN layers can be shared among diverse offloaded tasks to save memory resources at the edge; (2) a tailored number of common layers can be “frozen” while task-specific layers can be fine-tuned, to limit training costs, preserve previously acquired knowledge, and, at the same time, fulfill tasks accuracy requirements; (3) task-specific layers can be pruned in a customized manner to further save memory and computing time at the edge while meeting accuracy requirements. To best apply such innovations, we formulated an optimization problem that determines the most efficient DNNs configurations to be deployed, the tasks offloading rate that the edge can support, and the radio and computing resources to be allocated. We then envisioned a low-complexity solution strategy that efficiently and effectively solves the above (NPhard) problem.

While example embodiments have been particularly shown and described, it will be understood by those skilled in the art that various changes in form and details may be made therein without departing from the scope of the embodiments encompassed by the appended claims.

What is claimed is:

1. A system for distributing tasks, comprising:
a computing resource pool including computer hardware configured to execute tasks;
a deep neural network (DNN) repository comprising a plurality of DNN models;
a controller configured to:
receive a request to process a task from a device across a network,
determine a DNN configuration to process the task based on an identification of computing resources required to process the task,
allocate a subset of the computing resource pool to execute the task based on the DNN configuration,
activate a selected set of DNN blocks from the DNN repository based on the DNN configuration, and
enable the device to transmit input data to the subset of the computing resource pool to execute the task via the selected set of DNN blocks.

2. The system of claim 1, wherein the controller determines the DNN configuration by:
applying the task to a graph model representing a plurality of solution paths through a DNN structure; and
identifying a path of the plurality of solution paths, the path traversing a representation of the selected set of DNN blocks corresponding to the DNN configuration.

3. The system of claim 2, wherein the path is identified based on an indication of required computing resources to execute the task via the path.

4. The system of claim 2, wherein the path is identified based on a task admission ratio indicating a likelihood of the task being admitted for execution.

5. The system of claim 2, wherein the path is unassociated with unselected blocks from the DNN repository.

6. The system of claim 2, wherein the graph model comprises a plurality of nodes connected by links, the nodes each representing a decision to be made by the selection of DNN blocks.

7. The system of claim 6, wherein each of the plurality of nodes have attributes indicating required computing resources to execute the decision at the node.

8. The system of claim 7, wherein the controller is further configured to determine the required computing resources for the path based on the attributes of each node comprising the path.

9. The system of claim 1, wherein the controller is further configured to construct a dynamic DNN to execute the task, the dynamic DNN comprising the selected set of DNN blocks.

10. The system of claim 9, wherein the dynamic DNN comprises layers extracted from a plurality of different DNN models of the DNN repository.

11. The system of claim 1, wherein each of the subset of DNN blocks are one or more layers of the plurality of DNN models.

12. The system of claim 1, wherein the controller is further configured to allocate a transmission slot based on the DNN configuration, the transmission slot defining the transmission of the input data from the device to the selected set of DNN blocks.

13. A method of distributing tasks, comprising:
parsing a request to process a task from a device across a network;
determining a deep neural network (DNN) configuration to process the task based on an identification of computing resources required to process the task;
allocating a subset of a computing resource pool to execute the task based on the DNN configuration, the computing resource pool including computer hardware configured to execute tasks;
activating a selected set of DNN blocks from a DNN repository based on the DNN configuration, the repository comprising a plurality of DNN models, and
enabling the device to transmit input data to the subset of the computing resource pool to execute the task via the selected set of DNN blocks.

14. The method of claim 13, further comprising determining the DNN configuration by:
applying the task to a graph model representing a plurality of solution paths through a DNN structure; and
identifying a path of the plurality of solution paths, the path traversing a representation of the selected set of DNN blocks corresponding to the DNN configuration.

15. The method of claim 14, wherein the path is identified based on an indication of required computing resources to execute the task via the path.

16. The method of claim 14, wherein the path is identified based on a task admission ratio indicating a likelihood of the task being admitted for execution.

17. The method of claim 14, wherein the path is unassociated with unselected blocks from the DNN repository.

18. The method of claim 14, wherein the graph model comprises a plurality of nodes connected by links, the nodes each representing a decision to be made by the selection of DNN blocks.

19. The method of claim 18, wherein each of the plurality of nodes have attributes indicating required computing resources to execute the decision at the node.

20. The method of claim 19, further configured to determine the required computing resources for the path based on the attributes of each node comprising the path.

21. The method of claim 13, further comprising constructing a dynamic DNN to execute the task, the dynamic DNN comprising the selected set of DNN blocks.

22. The method of claim 21, wherein the dynamic DNN comprises layers extracted from a plurality of different DNN models of the DNN repository.

23. The method of claim 13, wherein each of the subset of DNN blocks are one or more layers of the plurality of DNN models.

24. The method of claim 13, further comprising allocating a transmission slot based on the DNN configuration, the transmission slot defining the transmission of the input data from the device to the selected set of DNN blocks.
